(19) United States
(12) Patent Application Publication
(10) Pub. No.: US 2004/0246871 A1
(43) Pub. Date: Dec. 9, 2004

(54) Compatible optical pickup apparatus

(75) Inventors: Kun-soo Kim, Seoul (KR); Euu-goo Kim, Suwon-si (KR); Sun-mook Park, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon City (KR)

(21) Appl. No.: 10/733,254

(22) Filed: Dec. 12, 2003

(30) Foreign Application Priority Data
Jan. 16, 2003 (KR) 03-2968

(51) Int. Cl. G11B 7/00

(52) U.S. Cl. 369/112.01; 369/53.26; 369/116; 369/44.37

(57) ABSTRACT

An optical pickup includes: a first light module which records information on and/or reproduces information from a first optical recording medium having a first format, radiates a first beam having a first wavelength, and receives the first beam reflected from the first optical recording medium to detect an information signal and an error signal; a second light module which records information on and/or reproduces information from a second optical recording medium having a second format different from the first, radiates a second beam having a second wavelength different from the first, and receives the second beam reflected from the second optical recording medium to detect an information signal and an error signal; a beam splitter disposed along paths of the first and second beams and which changes the paths of the first and second beams; and an objective lens which condenses the first and second light beams to form a light spot on the first and second optical recording media, respectively.

### CROSS-REFERENCE TO RELATED APPLICATIONS

This application claims the priority of Korean Patent Application No. 2003-2968, filed on Jan. 16, 2003, in the Korean Intellectual Property Office, the disclosure of which is incorporated herein in its entirety by reference.

### BACKGROUND OF THE INVENTION

1. Field of the Invention

The present invention relates to a compatible optical pickup apparatus for recording and reproducing information on optical recording media having different formats, and more particularly, to a compatible optical pickup apparatus using a hologram element.

2. Description of the Related Art

Generally, compatible optical pickup apparatuses record and reproduce information on optical recording media having different formats such as, for example, DVDs and CDs.

FIG. 1 schematically shows an optical arrangement of a conventional compatible optical pickup apparatus.

Referring to FIG. 1, the conventional compatible optical pickup apparatus includes a light source module 10, a second light source 21, first and second beam splitters 31 and 23, respectively, an objective lens 35, and a second photodetector 29. The light source module 10 radiates a first beam L1 having a wavelength and receives the first beam L1 reflected from an optical recording medium D. The second light source 21 radiates a second beam L2 having a different wavelength from the first beam L1 emitted from the light source module 10. The first and second beam splitters 31 and 23 change the paths of the first and second beams L1 and L2, respectively. The objective lens 35 condenses the first and second beams L1 and L2 to form a light spot on the optical recording medium D. The second photodetector 29 receives the second beam L2 reflected from the optical recording medium D and passed through the objective lens 35 and the first and second beam splitters to detect an information signal and an error signal.

The light source module 10 includes a first light source 11, a hologram element 13, and a first photodetector 15, which are formed in one body. Here, the first beam L1 emitted from the first light source 11 is transmitted straight by the hologram element 13 and proceeds to the optical recording medium D. Further, the first beam L1 reflected from the optical recording medium D is diffracted by the hologram element 13 and focused on the first photodetector 15, which is disposed adjacent to the first light source 11.

Meanwhile, a first collimating lens 17 is provided on an optical path between the light source module 10 and the first beam splitter 31 and first condenses divergent light incident from the first light source 11 to make the divergent light into parallel light.

Here, most of the first beam L1 emitted from the first light source 11 to the first beam splitter 31 is transmitted by the first beam splitter 31 and proceeds to the optical recording medium D, and a portion of the first beam L1 is reflected from the first beam splitter 31 and received by a monitoring photodetector 33.

The monitoring photodetector 33 enables determination of an optical output power of the first light source 11 by measuring the received portion of the first beam L1, and thus the optical output of the first light source 11 is appropriately controlled.

The second beam L2 emitted from the second light source 21 is reflected from the second beam splitter 23 and proceeds to the first beam splitter 31. Here, a second collimating lens 25 is provided on an optical path between the first beam splitter 31 and the second beam splitter 23 and condenses divergent light to make the divergent light into parallel light.

The first and second beam splitters 31 and 23 have a cubic shape in consideration of optical aberration. A sensor lens 27 is provided between the second beam splitter 23 and the second photodetector 29 to adjust a focal point of the second beam L2. The second lens 27 generates astigmatism in the optical pickup apparatus using an astigmatism method in order to detect a focus error signal.

The conventional compatible optical pickup apparatus having the above-described structure can monitor only the optical output power of the first light source by the monitoring photodetector 33. Thus, in a case where the first light source 11 is manufactured using a high-output semiconductor laser, the first beam L1 can be used for recording and reproducing information. However, since the conventional compatible optical pickup apparatus does not include an element that can monitor light emitted from the second light source 21, it is difficult to manufacture the second light source 21 using a high-output semiconductor laser. Therefore, the second beam L2 can be used only for reproducing information.

Further, since the optical structure of the conventional compatible optical pickup apparatus is complicated, it is difficult to reduce sizes and installation spaces of optical elements. As a result, it is difficult to reduce the size of the conventional compatible optical pickup apparatus.

### SUMMARY OF THE INVENTION

The present invention provides a compatible optical pickup apparatus that can record and reproduce information on optical recording media having different formats and can be made slim.

Additional aspects and/or advantages of the invention will be set forth in part in the description which follows and, in part, will be obvious from the description, or may be learned by practice of the invention.

In accordance with an aspect of the present invention, there is provided an optical pickup apparatus including: a first light module which one of records information on and reproduces information from a first optical recording medium having a first format, radiates a first beam having a first wavelength, and receives the first beam reflected from the first optical recording medium to detect an information signal and an error signal; a second light module which one of records information on and reproduces information from a second optical recording medium having a second format different from the first, radiates a second beam having a second wavelength different from the first, and receives the second beam reflected from the second optical recording medium to detect an information signal and an error signal; a beam splitter disposed along paths of the first and second beams and which changes the paths of the first and second beams; an objective lens which condenses the first and second light beams to form a light spot on the first and second optical recording media, respectively; and a monitoring photodetector disposed along the third light path, which receives the portions of the first and second light beams from the beam splitter so as to monitor powers of the first and second light modules.

According to another aspect of the present invention, there is provided an optical pickup including: a first light module which radiates a first beam having a first wavelength along a first light path, and receives the first beam reflected from a first optical recording medium to detect an information signal and an error signal; a second light module which radiates a second beam having a second wavelength different from the first along a second light path, and receives the second beam reflected from a second optical recording medium to detect an information signal and an error signal; a beam splitter disposed along the first and second light paths, which changes the first and second paths so that the first and second light paths coincide downstream of the beam splitter and which reflects a portion of the first and of the second light beams along a third light path; an objective lens disposed downstream of the beam splitter, which condenses the first and second beams to form a light spot on the first and second optical recording media, respectively; and a monitoring photodetector disposed along the third light path, which receives the portions of the first and second light beams so as to monitor powers of the first and second light modules.

According to still another aspect of the present invention, there is provided an optical pickup including: a first light module which radiates a first beam having a first wavelength along a first light path, and receives the first beam reflected from a first optical recording medium to detect an information signal and an error signal; a second light module which radiates a second beam having a second wavelength different from the first along a second light path, and receives the second beam reflected from a second optical recording medium to detect an information signal and an error signal; a cubic beam splitter disposed along the first and second light paths, which changes the first and second paths so that the first and second light paths coincide downstream of the beam splitter and which transmits a portion of the first and of the second light beams along a third light path; an objective lens disposed downstream of the cubic beam splitter, which condenses the first and second beams to form a light spot on the first and second optical recording media, respectively; and a monitoring photodetector disposed along the third light path, which receives the portions of the first and second light beams so as to monitor powers of the first and second light modules.

According to still another aspect of the present invention, there is provided a method of recording and/or reproducing information, including: radiating a first beam having a first wavelength and a second light beam having a second wavelength different from the first; receiving the first beam reflected from a first optical recording medium and the second light beam reflected from a second optical recording medium to detect information and error signals; changing the light paths of the first and second beams; and forming a light spot on the first and second optical recording media by condensing the first and second beams, respectively. The first optical recording medium has a first format and the second optical recording medium has a second format different from the first.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 schematically shows an optical arrangement of a conventional compatible optical pickup apparatus;

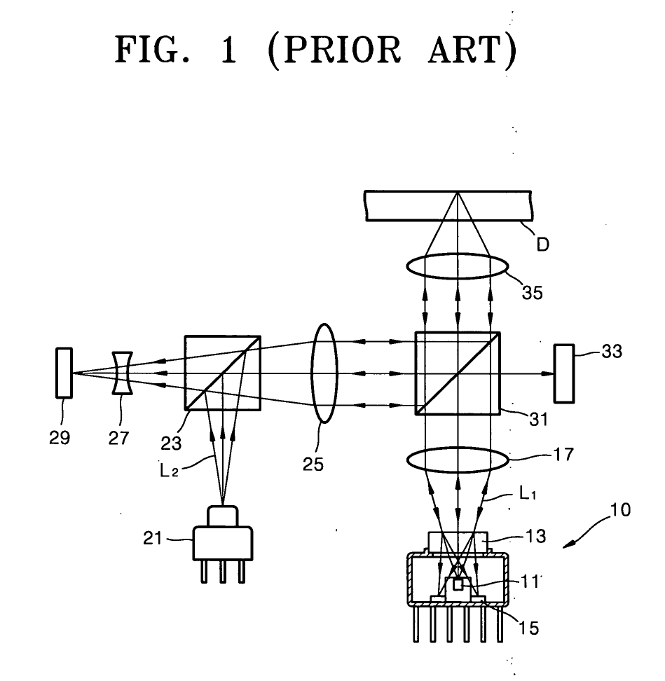

FIG. 2 schematically shows an optical arrangement of a compatible optical pickup apparatus according to a first embodiment of the present invention;

FIG. 3 schematically shows the wedge beam splitter of FIG. 2; and

FIG. 4 schematically shows an optical arrangement of a compatible optical pickup apparatus according to a second embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

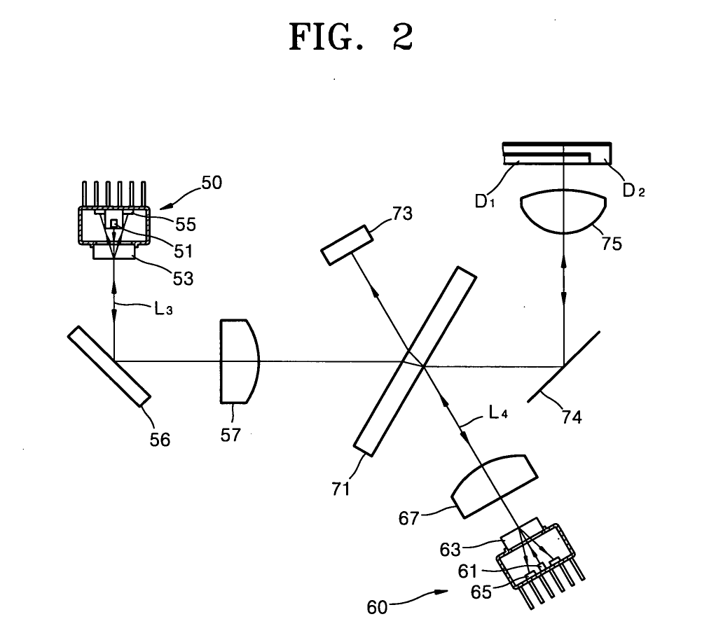

Referring to FIG. 2, a compatible optical pickup apparatus according to a first embodiment of the present invention includes a first light module 50, a second light module 60, a beam splitter 71, and an objective lens 75. The first light module 50 radiates a first beam L3 having a predetermined wavelength and receives the first beam L3 reflected from a first optical recording medium D1. The second light module 60 radiates a second beam L4 and receives the second beam L4 reflected from a second optical recording medium D2. The beam splitter 71 changes the paths of the first and second beams L3 and L4. The objective lens 75 condenses the first and second beams L3 and L4 incident from the first and second light modules 50 and 60 to form a light spot on each of the first and second optical recording media D1 and D2.

The first light module 50 is used to record and reproduce information on the first optical recording medium D1 having a first format, for example, a DVD. The first light module 50 includes a first light source 51 for emitting the first beam L3, a first hologram element 53 for changing the path of the first beam L3, and a first photodetector 55 for receiving the first beam L3 reflected from the first optical recording medium D1.

The first beam L3 incident from the first light source 51 is transmitted straight by the first hologram element 53 and proceeds to the beam splitter 71. Light incident from the beam splitter 71 is diffracted and proceeds to the first photodetector 55.

The first photodetector 55 is provided at a peripheral portion of the first light source 51 and receives the first beam L3 reflected from the first optical recording medium D1 and then passed through the beam splitter 71 to detect an information signal and an error signal.

The second light module 60 is used to record and reproduce information on the second optical recording medium D2 having a second format different from that of the first optical recording medium D1, for example, a CD. The second light module 60 includes a second light source 61 for emitting the second beam L4, a second hologram element 63 for changing the path of the second beam L4, and a second photodetector 65 for receiving the second beam L4 reflected from the second optical recording medium D2 to detect an information signal and an error signal.

The beam splitter 71 changes the paths of the first and second beams L3 and L4, respectively, so that the first and second beams L3 and L4 proceed to the objective lens 75 along the same optical path. Further, the beam splitter 71 may be a plate beam splitter with two parallel surfaces, or a wedge beam splitter. Particularly, in the case where the beam splitter 71 is a wedge beam splitter, optical aberration such as astigmatism and coma aberration can be minimized.

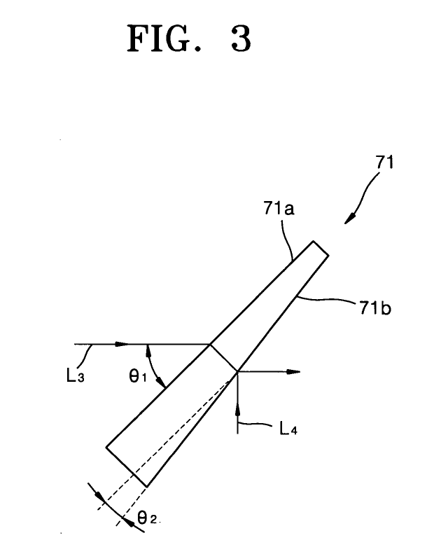

Referring to FIG. 3, the wedge beam splitter 71 includes an incident surface 71a which is inclined at an angle of θ1 to an optical axis of the first beam L3, and an emitting-reflecting surface 71b which is inclined at an angle of θ2 to the incident surface 71a. The incident surface 71a is disposed opposite to the first light source 51 (shown in FIG. 2) and transmits the first beam L3. The emitting-reflecting surface 71b transmits the first beam L3 transmitted through the incident surface 71a and reflects the second beam L4 so that the first beam L3 and the second beam L4 travel along the same optical path. Transmission and reflection according to a wavelength of light are determined by coating treatment methods of the incident surface 71 a and the emitting-reflecting surface 71b. Since a coating treatment method of the beam splitter is known, a description thereof will be omitted.

Here, the wedge angle of the wedge beam splitter 71, that is, the angle of inclination θ2 of the emitting-reflecting surface 71b is experimentally determined within a range in which optical aberration can be minimized. It is preferable that the angle of inclination θ2 satisfies the following Inequality 1.

0° ≦θ2≦5° (1)

Returning to FIG. 2, the compatible optical pickup apparatus according to the first embodiment of the present invention further includes first and second collimating lenses 57 and 67, which condense divergent light into parallel light.

The first collimating lens 57 is disposed on an optical path between the first light module 50 and the beam splitter 71 and condenses the first beam L3 emitted from the first light source 51 to make the first beam L3 into parallel light. The second collimating lens 67 is disposed on an optical path between the second light module 60 and the beam splitter 71 and condenses the second beam L4 emitted from the second light source 61 to make the second beam L4 into parallel light. Since the compatible optical pickup apparatus includes the first and second collimating lenses 57 and 67, the first and second light modules 50 and 60 can be disposed easily and the cross-sectional area of light transmitted by the beam splitter 71 can be adjusted. Thus, high optical output power can be obtained when recording information on the first and second optical recording media D1 and D2.

The compatible optical pickup apparatus according to the first embodiment of the present invention further includes a monitoring photodetector 73 which monitors the optical output of the first and second light modules 50 and 60 for control thereof by a controller (not shown). The monitoring photodetector 73 is disposed opposite to the beam splitter 71 and receives a portion of each of the first and second beams L3 and L4 emitted from the first and second light modules 50 and 60.

Further, a first mirror 56 is disposed on an optical path between the first light module 50 and the beam splitter 71 and changes the path of incident light by reflecting the incident light. A reflecting surface of the first mirror member is coated for phase shift so as to invert the polarization of the first beam L3. Thus, polarization of the first beam L3 emitted from the first light source 51 and then transmitted by the first hologram element 53 can be different from polarization of the first beam L3 reflected from the first optical recording medium D1. By making the polarization of the first beam L3 different as described above, the first beam L3 incident on the first hologram element is diffracted, transmitted, proceeds to the first photodetector 55.

The compatible optical pickup apparatus according to the first embodiment of the present invention further includes a second mirror member 74 which is disposed on an optical path between the beam splitter and the objective lens 75. The second mirror member 74 reflects the first and second beams L3 and L4 emitted from the first and second light modules 50 and 60 so that optical paths of the first and second beams L3 and L4 are changed and phases of the first and second beams are shifted. To do so, a reflecting surface of the second mirror member 74 is coated for phase shift as in the first mirror member 56. Here, since the phase shift coating of each of the first and second mirror members 56 and 74 is known, a description thereof will be omitted.

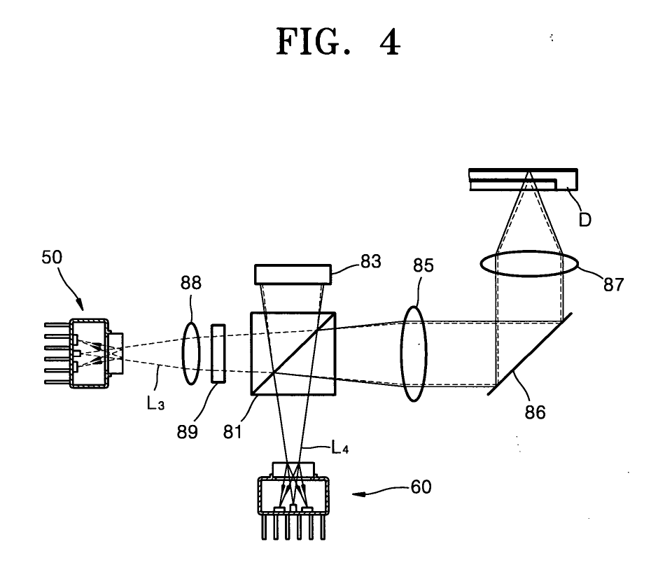

Referring to FIG. 4, a compatible optical pickup apparatus according to a second embodiment of the present invention includes first and second light modules 50 and 60, respectively, a beam splitter 81, and an objective lens 87. The first and second light modules 50 and 60 radiate first and second beams L3 and L4, respectively, and detect an information signal and an error signal. The beam splitter 81 changes the paths of the first and second beams L3 and L4. The objective lens 87 condenses the first and second beams L3 and L4 incident from the first and second light modules 50 and 60 to form a light spot on each of the first and second optical recording media D1 and D2.

Since the first and second light modules 50 and 60 are substantially the same as the first and second light modules of the compatible optical pickup apparatus according to the first embodiment of the present invention described with reference to FIG. 2, their descriptions will be omitted.

The compatible optical pickup apparatus according to the second embodiment of the present invention is different from the compatible optical pickup apparatus according to the first embodiment of the present invention in the use of a cubic beam splitter 81. Most of the first beam L3 emitted from the first light module 50 is transmitted straight by the cubic beam splitter 81 and proceeds to the objective lens 87. Most of the second beam L4 emitted from the second light module 60 is reflected by the cubic beam splitter 81 and proceeds to the objective lens 87. Here, a monitoring photodetector 83 is further provided on one surface opposite to the beam splitter 81. The monitoring photodetector 83 receives the remainders of the first and second beams L3 and L4 emitted from the first and second light modules 50 and 60 and respectively reflected or passed through the beam splitter 81, and monitors optical output of the first and second light modules 50 and 60 for control thereof by a controller (not shown).

A relay lens 88 is further disposed on an optical path between the first light module 50 and the beam splitter 81 and/or an optical path between the second light module 60 and the beam splitter 81 and converges or diverges incident light. In FIG. 4, the relay lens 88 is provided on the optical path between the first light module 50 and the beam splitter 81. Since the divergent angle of light emitted from the first light module 50 and/or second light module 60 can be adjusted by the relay lens 88, installation positions of the first light module 50 and/or second light module 60 with respect to the beam splitter 81 can be adjusted. Thus, installation spaces of optical elements such as a half-wavelength plate 89, which will be described below, can be secured between the first light module 50 and/or second light module 60, and the beam splitter 81.

The compatible optical pickup apparatus according to the second embodiment of the present invention further includes a collimating lens 85 which is disposed on an optical path between the beam splitter 81 and the objective lens 87. The collimating lens 85 condenses divergent light incident from the first and second light modules 50 and 60 to make the divergent light into parallel light.

The compatible optical pickup apparatus according to the second embodiment of the present invention further includes a mirror 86 which is disposed on an optical path between the beam splitter 81 and the objective lens 87. Since the mirror 86 is substantially the same as the second mirror (shown in FIG. 2) of the compatible optical pickup apparatus according to the first embodiment of the present invention, a description thereof will be omitted.

The half-wavelength plate 89 is disposed on an optical path between the first light module 50 and the beam splitter 81 or on an optical path between the second light module 60 and the beam splitter 81. The half-wavelength plate 89 delays the phase of incident light to change the polarization of the incident light. That is, vertical polarization is changed into horizontal polarization, and horizontal polarization is changed into vertical polarization.

The cubic beam splitter 81 is a polarized beam splitter for transmitting or reflecting incident light according to its polarization.

For example, the cubic beam splitter 81 is a polarized beam splitter which transmits horizontally polarized incident light and reflects vertically polarized incident light. Most of the first and second beams emitted from each of the first and second light modules 50 and 60 are vertically polarized light, and the half-wavelength plate 89 is disposed on the optical path between the first light module 50 and the beam splitter 81.

Vertically polarized light emitted from the first light module 50 is transmitted by the half-wavelength plate 89 and changed into horizontally polarized light. The horizontally polarized light is transmitted by the cubic beam splitter 81 and the proceeds to the optical recording medium D1. Meanwhile, horizontally polarized light emitted from the second light module 60 is reflected from the cubic beam splitter 81 and proceeds to the optical recording medium D2. The first and second beams L3 and L4 reflected from the optical recording media D1 and D2 are incident on the cubic beam splitter 81. Next, the first beam L3 of vertically polarized light is transmitted by the cubic beam splitter 81 and proceeds to the first light module 50, and the second beam L4 of horizontally polarized light is reflected from the cubic beam splitter 81 and proceeds to the second light module 60.

Meanwhile, the half-wavelength plate 89 may be replaced by a quarter-wavelength plate in consideration of diffraction patterns of first and second hologram elements of the first and second light modules 50 and 60. That is, as described above, in the case of using the quarter-wavelength plate, beams reflected from the optical recording media D1 and D2 are reflected from the first and second light sources 51 and 61 again so that the beams can be prevented from acting as feed-back noise.

A compatible optical pickup apparatus according to the present invention configured as described above can record and reproduce information on optical recording media having different formats, for examples, CDs and DVDs. Further, since first and second light modules use a hologram element, the structure of the optical system is simple. Thus, the number of assembling operations and manufacturing costs can be reduced. In addition, the compatible optical pickup apparatus according to the present invention can be made simple.

Although a few embodiments of the present invention have been shown and described, the present invention is not limited to the disclosed embodiments. Rather, it would be appreciated by those skilled in the art that changes may be made in this embodiment without departing from the principles and spirit of the invention, the scope of which is defined by the claims and their equivalents.

What is claimed is:

1. A compatible optical pickup apparatus comprising:
a first light module which one of records information on and reproduces information from a first optical recording medium having a first format, radiates a first beam having a first wavelength, and receives the first beam reflected from the first optical recording medium to detect an information signal and an error signal;
a second light module which one of records information on and reproduces information from a second optical recording medium having a second format different from the first format, radiates a second beam having a second wavelength different from the first wavelength, and receives the second beam reflected from the second optical recording medium to detect an information signal and an error signal;
a beam splitter disposed along paths of the first and second beams and which changes the paths of the first and second light beams;
an objective lens which condenses the first and second light beams to form a light spot on the first and second optical recording media, respectively; and
a monitoring photodetector disposed along a third light path, which receives the portions of the first and second light beams from the beam splitter so as to monitor powers of the first and second light modules.

2. The compatible optical pickup apparatus of claim 1, wherein the first light module comprises:
a first light source which emits the first beam;
a first photodetector which receives the first beam reflected from the first optical recording medium and passed through the beam splitter to detect an information signal and an error signal; and
a first hologram element which transmits the first beam so that the first beam proceeds to the beam splitter, and diffracts the reflected first beam so that the diffracted light proceeds to the first photodetector.

3. The compatible optical pickup apparatus of claim 2, wherein the second light module comprises:
a second light source which emits the second beam;
a second photodetector which receives the second beam reflected from the second optical recording medium and passed through the beam splitter to detect an information signal and an error signal; and
a second hologram element which transmits the second beam so that the second beam proceeds to the beam splitter, and diffracts the reflected second beam so that the diffracted light proceeds the second photodetector.

4. The compatible optical pickup apparatus of claim 1, wherein the beam splitter is one of a plate beam splitter with two parallel surfaces and a wedge beam splitter with two oblique surfaces.

5. The compatible optical pickup apparatus of claim 4, wherein the beam splitter is a wedge beam splitter having an incident surface which is inclined at an angle of θ1 to an optical axis of the first beam to transmit the first beam, and an emitting-reflecting surface which is inclined at an angle of θ2 to the incident surface to transmit the first beam and reflect the second beam, wherein 0°≦θ2≦5°.

6. The compatible optical pickup apparatus of claim 4, wherein the beam splitter is a wedge beam splitter having an emitting-reflecting surface coated by a coating which causes the emitting-reflecting surface to one of transmit or reflect incident light based on wavelength, and wherein the emitting-reflecting surface transmits the first beam and reflects the second beam according to the first wavelength and the second wavelength, respectively.

7. The compatible optical pickup apparatus of claim 1, further comprising first and second collimating lenses which are respectively disposed on an optical path between the first light module and the beam splitter and an optical path between the second light module and the beam splitter.

8. The compatible optical pickup apparatus of claim 7, wherein a cross-sectional area of the light transmitted by the beam splitter is adjustable by varying a distance between the first and second light modules and the first and second collimating lenses, respectively.

9. The compatible optical pickup apparatus of claim 1, further comprising a first mirror disposed on an optical path between the first light module and the beam splitter, which reflects the first beam emitted from the first light module so that the path of the first beam is changed and the phase of the first beam is shifted.

10. The compatible optical pickup apparatus of claim 9, wherein the first mirror is coated with a coating which shifts the phase of the first beam so as to invert a polarization of the first beam.

11. The compatible optical pickup apparatus of claim 1, further comprising a second mirror disposed on an optical path between the beam splitter and the objective lens which and reflects the first and second beams emitted from the first and second light modules so that the paths of the first and second beams are changed and phases of the first and second beams are shifted.

12. The compatible optical pickup apparatus of claim 11, wherein the second mirror is coated with a coating which shifts the phase of the second beam so as to invert a polarization of the second beam.

13. The compatible optical pickup apparatus of claim 1, wherein optical output of the first and second light modules is controlled by a controller based on the received portions of the first and second beams.

14. The compatible optical pickup apparatus of claim 1, wherein the beam splitter is a cubic beam splitter which transmits most of the first beam emitted from the first light module so that most of the first beam proceeds to the objective lens, and reflects most of the second beam emitted from the second light module so that most of the second beam proceeds to the objective lens.

15. The compatible optical pickup apparatus of claim 14, further comprising a half-wavelength plate disposed on one of an optical path between the first light module and the beam splitter and an optical path between the second light module and the beam splitter and which delays a phase of incident light to change the polarization of the incident light.

16. The compatible optical pickup apparatus of claim 14, further comprising a relay lens disposed on one of an optical path between the first light module and the beam splitter and an optical path between the second light module and the beam splitter and which changes a divergent angle of incident light.

17. The compatible optical pickup apparatus of claim 14, further comprising a collimating lens disposed on an optical path between the beam splitter and the objective lens which condenses divergent light incident from the first and second light modules to convert the divergent light into parallel light.

18. An optical pickup comprising:
a first light module which radiates a first beam having a first wavelength along a first light path, and receives the first beam reflected from a first optical recording medium to detect an information signal and an error signal;
a second light module which radiates a second beam having a second wavelength different from the first along a second light path, and receives the second beam reflected from a second optical recording medium to detect an information signal and an error signal;
a beam splitter disposed along the first and second light paths, which changes the first and second paths so that the first and second light paths coincide downstream of the beam splitter and which reflects a portion of the first and of the second light beams along a third light path;
an objective lens disposed downstream of the beam splitter, which condenses the first and second beams to form a light spot on the first and second optical recording media, respectively,
a monitoring photodetector disposed along the third light path, which receives the portions of the first and second light beams so as to monitor powers of the first and second light modules.

19. The optical pickup of claim 18, wherein the fist and second optical recording media use different formats.

20. The optical pickup of claim 18, wherein the monitoring photodetector opposes the beam splitter.

21. The optical pickup of claim 18, wherein the monitoring photodetector outputs a control signal based on the monitored powers of the first and second light beams which is usable to control the output of the first and second light modules.

22. A method of recording and/or reproducing information, comprising:
radiating a first beam having a first wavelength and a second light beam having a second wavelength different from the first;
receiving the first beam reflected from a first optical recording medium and the second light beam reflected from a second optical recording medium to detect information and error signals;
changing the light paths of the first and second beams; and
forming a light spot on the first and second optical recording media by condensing the first and second beams, respectively,
wherein the first optical recording medium has a first format and the second optical recording medium has a second format different from the first.
